(19) United States
(12) Patent Application Publication
(10) Pub. No.: US 2026/0278517 A1
(43) Pub. Date: Sep. 17, 2026

(54) CONSTRUCTION NETWORKING APPLICATION FOR CONSTRUCTION PROJECT MANAGEMENT, CONSTRUCTION MATERIAL ORDERING AND DELIVERY, CONSTRUCTION RETAL EQUIPMENT PROCUREMENT, CONSTRUCTION LABOR PROCUREMENT AND METHODS IMPLEMENTING THE SAME

(71) Applicant: Tuler Technologies, LLC, Uniontown, PA (US)

(72) Inventors: Andrew Zock, Uniontown, PA (US); David John Stadelman, Uniontown, PA (US); Christopher Oslosky, Trafford, PA (US)

(21) Appl. No.: 19/552,270

(22) Filed: Feb. 27, 2026

Related U.S. Application Data
(63) Continuation of application No. 17/689,948, filed on Mar. 8, 2022, now abandoned.
(60) Provisional application No. 63/157,843, filed on Mar. 8, 2021.

(51) Int. Cl. G06Q 10/083; G06Q 30/0645; G06Q 50/08

(52) U.S. Cl. CPC G06Q 10/083; G06Q 30/0645; G06Q 50/08

(57) ABSTRACT

A construction networking application system, preferably downloadable, includes a project management component allowing network users engage network project managers to manage a construction job; a construction material order and delivery component wherein network users order construction materials from network vendors which are delivered by network drivers to a designated job site; a construction equipment rental component wherein network users rent construction equipment from network vendors for a designated job site, and wherein the system pre-approves the network user for the rental requirements associated with the desired rental construction equipment and the network vendor; and a construction labor component wherein network users hires temporary laborers for a designated job site; and wherein there is cross-platform interaction between the application components and wherein the system utilizes location tracking, such as GPS, for co-ordination.

### RELATED APPLICATIONS

This application is a Continuation of U.S. patent application Ser. No. 17/689,948 Filed Mar. 8, 2022 titled “Construction Networking Application for Construction Project Management, Construction Material Ordering and Delivery, Construction Rental Equipment Procurement, Construction Labor Procurement and Methods Implementing the Same” which application is incorporated herein by reference.

This application claims the benefit of U.S. Provisional Patent Application Ser. No. 63/157,843, filed Mar. 8, 2021 titled “Construction Networking Application for Construction Project Management, Construction Material Ordering and Delivery, Construction Rental Equipment Procurement, Construction Labor Procurement and Methods Implementing the Same” which application is incorporated herein by reference.

### BACKGROUND OF THE INVENTION

### 1. Field of the Invention

The present invention relates to construction project management, construction material ordering and delivery, construction rental equipment procurement, construction labor procurement and a construction related application and methods implementing the same.

### 2. Background Information

Construction management has been described as a service that uses project management techniques to oversee the planning, design, and construction of a construction project, from its beginning to its end. The purpose of construction management is to control a project's delivery time, cost and quality—sometimes referred to as a project management triangle or “triple constraints.” Professional construction managers that are separate from the general contractor have historically been reserved for lengthy, large-scale, high budget undertakings, such as commercial real estate, transportation infrastructure, industrial facilities, and military infrastructure.

The functions of construction management typically include the following: Specifying project objectives and plans including delineation of scope, budgeting, scheduling, setting performance requirements, and selecting project participants; Maximizing the resource efficiency through procurement of labor, materials and equipment; Implementing various operations through proper coordination and control of planning, design, estimating, contracting and construction in the entire process; and finally Developing effective communications and mechanisms for resolving conflicts. The Construction Management Association of America (CMAA) states the most common responsibilities of a Construction Manager fall into the following categories: Project Management Planning, Cost Management, Time Management, Quality Management, Contract Administration, Safety Management, and construction management Professional Practice. construction management professional practice includes specific activities, such as defining the responsibilities and management structure of the project management team, organizing and leading by implementing project controls, defining roles and responsibilities, developing communication protocols, and identifying elements of project design and construction likely to give rise to disputes and claims.

There are commercially available mobile applications or apps to assist construction managers, including those managers that identify as general contractors, to perform their functions. For example, the COCONSTRUCT™ software is a construction project app that is intended to provide custom home builders and remodelers with tools for managing projects, financials and clients. The app allows users to sync data from estimates, specifications, selections, bids, change orders, and budgets with QuickBooks Desktop or Online. Users can manage their projects from their tablet or desktop, in the field using the mobile app, and the system offers scheduling, communication, client and subcontractor management, file management, a job log, change order tracking, construction project management, warranty tracking, and more. The project manager is intended to aid communication by allowing builders, contractors, and other team members to track to-dos, coordinate schedules, sync complex installations, and track jobsite activities. The project management tool is intended to aid with prospecting, estimating, and bidding and to streamline client communication by offering email, text, and SMS communication stored in one place.

HOUZZ PRO™ software is another representative project management app designed for businesses in the home remodeling and design industries. The software is intended to streamline processes for businesses of all size by arguably centralizing all business needs into one place. The app includes a 3D floor planner, project management, lead management with client dashboards, and individual insights. Additional features include an integrated online payment system, mood boards for projects, and white-labeling. The tool is designed to manage contractor clients and track progress for any project. Using this app contracting professionals can allegedly grow client lists and streamline communication between clients using Client dashboards. Contracting professionals can use the app to convert project discussion into a potential project and store client notes and initial estimations for improved follow-ups.

UDA Technologies' CONSTRUCTIONONLINE™ software offers a web-based, integrated project management, project scheduling, and customer management app. Designed for emerging construction businesses in the homebuilding and remodeling industries, the app intends to allow users to remain apprised of all project changes and updates. The solution includes Gantt chart style schedules, where tasks can be converted into groups. The project management module provides photo management features, includes document control and intends to help with budgeting and cost management.

PROCORE® brand construction software is designed for professional project managers to allow them to manage their projects, resources and financials from project planning to closeout. The platform connects every project contributor with the owner and general or specialty contractor. The centralized dashboard allows managers to handle project details, schedule tasks and view progress. The App comes with an “app marketplace”, which offers over “150 partner solutions” (e.g., separate apps) that integrate seamlessly with the platform. It enables users to communicate across disparate teams, allegedly making it easier to work together by eliminating “silos” and establishing a single source of information.

The construction manager's project management techniques, including apps to assist therein, have not generally been available to residential homeowners. The residential homeowners have been relegated to either hiring a general contractor or embarking on a do it yourself (DYI) path. Assistance for the DYI homeowner is often limited to tutorial videos available on YOUTUBE® websites, and Material Supplier Store Apps, such as the HOME DEPOT® app. The HOME DEPOT® app does allow users to browse for the supplies they know they need among the products that the store offers for sale. Searching may be with voice commands or even photos of the items desired. When supplies are selected, a user can order them delivered straight to a home, or a user can look up the exact aisle where one will be able to find them at your local store.

Contractors in the construction industry often run into issues in which a shortage of supplies will jeopardize the full work day of a crew. The Material Supplier Store Apps, such as the HOME DEPOT® app, discussed above can be used to ordered the supplies once the shortfall is recognized, but the work crew typically cannot wait around while the supply store can get around to delivery of the requested supplies (which are often grouped with a number of separate deliveries along a routed delivery path). Thus the work crew will often send the lowest paid worker to pick up the supplies, but then the crew loses that worker for the time it takes to travel to the store, pick up the supplies and return to the job site with the supplies. The lost work must be handled (possibly at time and ½) and even at $15.00/hour this can be an expensive delivery. The problem is only exacerbated if a higher paid worker is sent, such as the case where the supplies are non-fungible goods requiring some discernment in their selection. Existing construction management apps can help with supply management to minimize this issue but they do not help with the unexpected supply shortfalls ubiquitous in many jobs. For examples product supplies that become damaged or otherwise unusable in shipment or onsite are common.

Construction equipment rental represents another area which can needlessly delay and complicate construction projects. Every contractor or homeowner does not always have the construction equipment necessary for every job, hence construction equipment rental is a big industry for specialty construction equipment, such as a backhoe or an electric floor sander. However there is often a number of prerequisites needed to be verified by the rental agency before the equipment can be rented. For example some equipment will require a special license by the intended operator as well as appropriate insurance to protect the operator and the rental agency. Thus there can be a significant down time at the rental agency while these prerequisites are verified and the rental agreement is filled out, further having the rental agency personnel perform these verifications personally with the renter can add to the costs. Conventional construction management applications do not address these issue.

Construction labor procurement for temporary labor is also something that is difficult for many contractors and largely impossible for homeowners to accomplish while still complying with U.S. labor requirements. Contractors, or even homeowners with a large DYI project, will need laborers on a crew to finish a project in the requisite time (and project bonuses may depend upon such timely completion). Reviewing unskilled laborers from a work history standpoint is largely impractical and generally skipped altogether. Further, these workers are often considered 1099 employees, or self-employed workers, also called independent contractors. In the United States, Form 1099 reports the income that independent contractors receive throughout the year to the IRS for tax purposes. This form replaces the need for a W-2 and indicates that they are not an employee, no employer is responsible for paying FICA taxes or withholding income tax, and the independent contractor is responsible for paying self-employment Taxes. Filling out and sending 1099's is often skipped and such practice fails to comply with U.S. Tax laws. Further, there are federal guidelines (FLSA 6 prong test or the IRS 3 prong test) as to who can qualify as a 1099 employee. Tragically, misclassifications of 1099 employees can put the employer at high risk for multiple penalties, fines, and back-taxes. Making a complex situation even more complex for people merely trying to give someone else meaningful work, is that regulations may vary from state to state, and thus proper classification must include consideration of applicable state law—for instance, California's ABC test is more demanding then federal guidelines. Finally is desired, and often required, for workers to be covered by insurance, and complicating the insurance further is that skilled workers can have differing insurance requirements than unskilled workers. Currently commercially available construction management apps available today do not adequately address these labor procurement issues in a meaningful manner.

There is a need for effective and efficient construction management apps that addresses the construction project management, construction material ordering and delivery, construction equipment rental and construction labor procurement issues outlined above.

### SUMMARY OF THE INVENTION

It is an object of the present invention to provide for an effective and efficient construction management app that addresses the construction project management, construction material ordering and delivery, construction rental equipment procurement and construction labor procurement issues.

One aspect of the present invention provides a construction networking application system, preferably a downloadable app, comprising: a project management component allowing network users to selectively engage network project managers to manage a construction job at an associated jobsite; a construction material order and delivery component wherein network users can order construction materials from network vendors and have the ordered construction materials delivered by network drivers to a designated job site, wherein the system utilizes location tracking, such as GPS, for co-ordination of network vendors and network drivers for an order and an associated job site; a construction equipment rental component wherein network users can rent construction equipment from network vendors for a designated job site, wherein the system utilizes location tracking, such as GPS, for co-ordination of network vendors an associated job site, and wherein the system pre-approves the network user for the rental requirements associated with the desired rental construction equipment and the network vendor; and a construction labor component wherein network users can hire temporary laborers for a designated job site, wherein the system utilizes location tracking, such as GPS, for co-ordination of temporary laborers and an associated job site; and wherein there is cross-platform interaction between the application components.

These and other advantages of the present invention will be clarified in the following description taken together with the attached figures.

### BRIEF DESCRIPTION OF THE FIGURES

FIG. 1 is a schematic flow chart of a construction networking application system or platform according to the present invention and the interaction with nine classifications of users of the system;

FIG. 2 is a schematic flow chart of the operational and labor flow of the construction networking application system or platform according to the present invention;

FIG. 3 is a schematic flow chart of the construction material and delivery component of the construction networking application system or platform according to the present invention;

FIG. 4 is a schematic flow chart of the construction equipment rental component of the construction networking application system or platform according to the present invention; and

FIG. 5 schematically illustrates the relationships among the working components of the system of the present invention.

### DESCRIPTION OF THE PREFERRED EMBODIMENTS

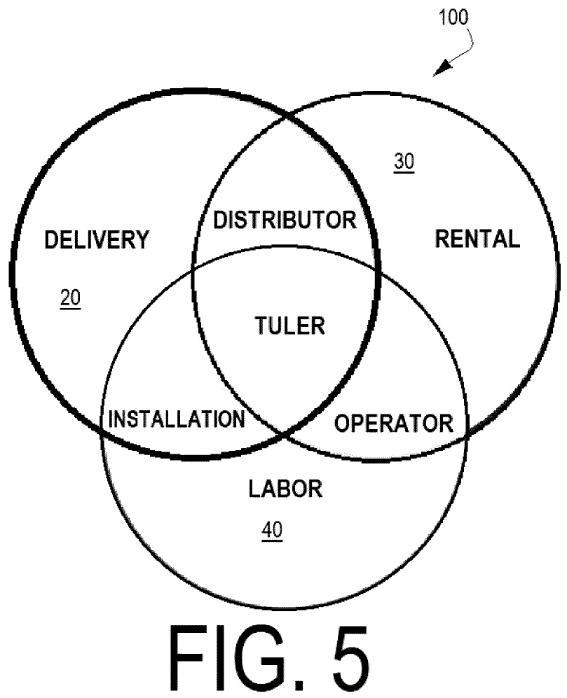

The present invention provides a construction networking application system or platform 100, preferably implemented by users as a downloadable app. The relationship of the various components and stakeholder of the system 100 are shown in FIG. 5 and will be explained in detail below.

The term application, or app, herein references software applications. The present platform 100 is an internet or cloud based platform for the construction industry. Cloud computing, also on-demand computing, is a well-established Internet-based computing that generally provides shared processing resources and data to computers and other devices on demand.

Specifically, the platform 100 is a software as a service (SaaS) model, in which network users gain access to application software or platform 100 via the cloud (or web), such as via an app store. An app store (or app marketplace) is a conventional type of digital distribution platform for computer software, generally in a mobile context. The platform sponsor or publisher, also called Cloud providers, manage the infrastructure that run the app or platform 100, and will update the platform 100 such as to incorporate new vendors, laborers, drivers into the platform 100, modify insurance particulars, and address ongoing regulation updates from regulating authorities. SaaS is sometimes referred to as “on-demand software.”

The platform 100 sponsor in the implementation of the present invention is the applicant Tuler Technologies, Inc., referenced as Tuler herein. Thus, the term Tuler as used herein is referencing the platform and/or the sponsors and not the brand name.

Some aspects of the platform 100, such as construction material ordering and delivery 20 may be accessed using verbal commands when the application or system 100 is active on a user's device. Software activated by voice commands, common in what is known as AI based personal assistant devices, often utilize a leading keyword or phrase to indicate that a voice command follows, and the platform 100 may implement the same technique. Specifically, for example, “Hey TULI” is a representative example of an activation phrase for voice activated components.

Some aspects of the platform 100, such as construction material ordering and delivery 20 may be accessed using a one push “Call in” button when the application or system 100 is active on a user's device. The call in button will place a call from the user to an on-call live sponsor representative, who will take the order and place it into the system 100 (or engage with the platform as needed by the user). The Call in button allows users who may be less comfortable navigating an online app use the platform 100, and or allows the users to have questions answered about the operation of the platform. The Call in feature may have a surcharge or be limited to VIP service. The on-call live sponsor representative will effectively engage with the system 100 in the same manner as the user could have on his device such that the Call In feature does not change the system architecture significantly, but can be key to rapid system 100 adoption in the construction industry.

The alternative voice activation and/or call in features are believed to particularly useful as users needing construction material in the field may otherwise have a considerable delay from when they realize they need certain materials and when they can clean their hands sufficiently to significantly manually interact with their phones or (with the voice activation) even get to a location in which they feel safe in taking out their phones from a protecting pocket. Remote voice activation and/or the call in button of platform 100 are also particularly helpful for access to the platform 100 while driving, such as for example by network drivers who are detailed below. The implementation of the AI necessary for voice activation and for a one button call in feature are otherwise known in the art.

Mobile apps, within the meaning of this patent application, when referencing the platform 100 indicates that the platform 100 is available as a downloadable application from the cloud/internet and is fully functional on portable handheld devices of users.

### Handheld Devices

The portable handheld devices of the users are typically smartphones or tablets. As generally known, a smartphone is a mobile phone with an advanced mobile operating system which combines features of a personal computer operating system with other features useful for mobile or handheld use. Smartphones typically combine the features of a cell phone with those of other popular mobile devices (such as what was previously known as a personal digital assistant (PDA)) media player, GPS navigation unit and digital camera. Smartphones can access the Internet and can run third-party apps, such as the platform 100. Smartphones have a touchscreen user interface, with LCD, OLED, AMOLED, LED or similar screen. Smartphones produced from 2012 onwards typically have high-speed mobile broadband 4G LTE, motion sensors, and the capability for mobile payment.

A tablet, or tablet computer, is a mobile computer with a touchscreen display, circuitry, and battery in a single device. Tablets come equipped with sensors, including cameras, a microphone, and an accelerometer, and the touchscreen display uses the recognition of finger or stylus gestures replacing the usage of the mouse and keyboard. Tablets are typically larger than smartphones with screens 7 inches (18 cm) or larger, measured diagonally. The portable handheld devices herein are not limited to smartphones or tablets, and may include laptops or other devices, but the platform is optimized for the smartphone or tablet usage.

### Location Tracking

Location tracking in the present application references the ability to track user locations generally through their portable hand held devices. The platform 100, like many modern interactive apps, such as weather applications or map application, need to find user location for implementation of the platform 100 functionality.

Smartphones and some laptops can implement this easily because of the GPS that can pinpoint the location to a few meters. GPS stands for Global Positioning System. It's a technology developed by the U.S. Navy and currently owned by the U.S. government and overseen by its Air Force. It's free for everyone to use and primarily a North American utility even though GPS is commonly a regional name for the same sort of system in other locales.

GPS is a radio navigation system. It uses radio waves between satellites and a receiver inside a portable handheld device, e.g., a smartphone, to provide location and time information to any software that needs to use it. The portable handheld devices only needs to be able to receive data from a number of the 28 satellites sufficient for triangulation of the position. Three satellites are needed for a map based position while four are needed if altitude is included.

GPS is precise. Each satellite has its own internal atomic clock and sends a time-coded signal on a specific frequency. A GPS receiver chip determines which satellites are visible and unobstructed then starts gathering data from the satellites with the strongest signals. GPS data is slow, by design due mainly to power requirements.

Many cellular devices use an Assisted GPS, or AGPS, to supplement the GPS data. AGPS adds cellular location data to assist geolocation. A cellular phone carrier knows the physical location of a cellular device as the device “pings” cell towers. AGPS software on a cellular device generally feeds this raw cellular location data to the GPS receiver, which will periodically switch between GPS data and cellular location to get a very close approximation (within 50 meters or so) in real-time. In other words, GPS location tracking can use data collected by a cellular device from the cell site it is connected to in order to work faster and more accurately.

There is another way that the platform 100 can implement to find a user's location, and that is through the IP (internet protocol) pinging. The data can be monitored for the location of the endpoint terminal (e.g. a user's phone or Router). With the use of a user's Wi-Fi router and the Wi-Fi connections near it, the user's location can be triangulated to within a few yards. If the user is using a cable or DSL provider, at least in the USA, the user location determined from IP pinging will be accurate. Further, if the user is using public Wi-Fi or a smartphone's hotspot, then the calculated location will be accurate. If the user receives internet service from an ISP (internet Service Provider), then IP pinging may result in the location placed in the wrong location as a user's ISP doesn't always provide the location service properly. The last location that is sent back is the last building/terminal of the ISP before it reaches the user, which could be miles away from the user's correct location. There may be other reasons as well that can lead to the wrong location information. Thus the platform 100 can allow users, such as a vendor, to set a default location for the user (or store locations of the user, or job sites of the user, etc.) to use when the correct address cannot be determined. Personal computers have also implemented default locations for users to designate to facilitate the operation of interactive applications, such as the platform 100 of the invention.

### Website

The platform 100 sponsor, Tuler, will maintain a web presence, or user accessible web page or home page, preferably with “responsive web design”, which generally means the display and interaction of the web page is scaled to the designated device, from desktop down to smartphone. The web page is where non-users can access the network or system 100, learn about the network 100, interact with the network 100 and join the network 100 by downloading the application (in addition to at the “app stores”).

The platform 100 or network of the present invention may be effectively implemented without a separate downloadable app component and solely as a website with responsive web design, which may be called, for mobile devices, a mobile web design or mobile website. Technically a mobile website is similar to any other website in that it consists of browser-based HTML pages that are linked together and accessed over the Internet (for mobile typically WiFi or 3G or 4G networks), however the characteristic that distinguishes a “mobile website” from a standard website is the fact that it is designed for the smaller handheld display and touch-screen interface. Mobile websites can access mobile-specific features such as click-to-call (the call in feature to dial a phone number) or location-based mapping that are used in implementing the network 100 of the invention.

Mobile websites actually have a number of advantages over downloadable apps in that a mobile website is instantly accessible to users via a browser across a range of devices (iPhone, Android, BlackBerry, etc.). Apps on the other hand require the user to first download and install the app from an app marketplace or website before the content or application can be viewed. This can be a significant barrier between initial engagement and action/conversion. Further, a single mobile website can reach users across many different types of mobile devices, whereas native apps often require a separate version to be developed for each type of device. Furthermore, mobile website URLs are easily integrated within other mobile technologies such as SMS, QR Codes and near field communication (NFC). A mobile website is generally more dynamic than an app in terms of pure flexibility to update content. Changes in the design or content of a mobile website requires publication of the edit once and the changes are immediately visible; while updating an app on the other hand requires the updates to be pushed to users, which then must be downloaded in order to update the app on each type of device. Mobile websites are generally easier for users to find because their pages can be displayed in search results and listed in industry-specific directories. Visitors to a regular website can be automatically sent to the mobile site/version when they are on a handheld (using device-detection). Mobile website URLs are also easily shared between users via a simple link (e.g. within an email or text message, Facebook or Twitter post). Publishers can easily direct users to a mobile website from a blog or website, or even in print. An app simply cannot be shared in this fashion.

In light of these advantages the “downloadable app” of the platform 100, may merely be a shortcut that opens the mobile website for the user. The traditional downloadable application is still a part of the preferred implementation of the platform 100 of the present invention because of the additional advantages offered by downloadable apps. A native app provides a great way to allow user personification, and a native application can effectively and efficiently manipulate data with complex calculations, charts and reports, such as happens in financial or scientific application tools. Further, although mobile web browsers are getting increasingly good at accessing certain mobile-specific functions such as click-to-call, SMS, device libraries and GPS functions, the need to access a user's camera and processing power in implementing the network solution of the platform 100 suggests an app version will do that much more effectively. The downloadable app implementation of the platform 100 provides offline access to content to perform functions without a network/wireless connection, as the platform can store the data locally and then have it upload once a connection is established.

Additionally supporting the downloadable application format is that an inherent capability of apps is the ability to send push notifications to users who have the app installed on their device, giving the Tuler run app of the platform 100 the easy ability to send messaging to users directly. This of course assumes the user has allowed the app to send push notifications in their settings. However, in support of the website only implementation it is noted that many browsers now allow web-based push notifications, allowing website owners to similarly send notifications to visitors who opt-in on both desktop and compatible mobile devices.

The preferred implementation of the present invention is both a web page and a downloadable app component wherein the Tuler home page of the platform 100 is a responsive web design that can be accessed and utilized on mobile devices as a mobile website for functionality to users, but the full implementation is intended to have users download a mobile application for access to the platform.

### Network Users

As noted above the present invention is a construction networking application system or platform 100, the Tuler platform, preferably fully implemented by users as a downloadable app. The users of the Tuler platform are in several distinct groups each with their own interaction with the system 100.

The first category of user is a Customer User also called a homeowner or DIY user. This user does not have to be a residential homeowner, but merely a user owning or controlling the job site of a construction job for which the Tuler platform 100 is being implemented. Commonly, this can be a homeowner tackling a DIY project. However it need not be so limited, for example the owner of an apartment building complex, or the manager of an office building complex, or the like could also easily be such a Consumer User. The residential homeowner tackling a DIY project is simply the easiest Consumer User to understand the operation of the network 100 of the invention.

The second category of Tuler network users is the Network Project Managers. Network Project Managers are engaged by Customer Users to manage a construction job at an associated jobsite. One aspect of the operation of the network 100 of the invention is that the Network Project Managers may be internalized to the Tuler network such that they, preferably, do not get paid by the profit on a job, which differentiates their functions from a general contractor who handles a given job. The role of the Network Project Managers is to control a project's time/delivery, cost and quality. The Network Project Managers will specifying project objectives and plans including delineation of scope, budgeting, scheduling, setting performance requirements, and selecting project participants. The Network Project Managers will utilize the network 100 as outlined herein to maximizing the resource efficiency through procurement of labor, materials and equipment. The Network Project Managers provide proper coordination and control of planning, design, estimating, contracting and construction of the entire process through the network. The use of the Tuler network 100 gives Network Project Managers effective communication with users and a mechanism for reducing and resolving conflicts.

The third category of Tuler network users is the construction material vendors which are network vendors of construction materials. These can be large commercial outlets like 84 Lumber, Home Depo or Lowes; or smaller vendors like local concrete suppliers, lumber yards, brick and block suppliers, plumbing supply houses, etc. These can be manufacturers for other construction material vendors, like cabinet makers and the like. The construction material vendors will provide the physical location of the individual stores as well the inventory for the individual stores.

The fourth category of Tuler network users is the network drivers for the delivery of construction materials from construction material vendors to a given job site. The network drivers are preferably independent of the construction material vendors and the network 100 or sponser, and may be generally categorized or described as “side-giggers.”

A side-gigger is sometimes defined as a person who does regular independent work, but for less than fifteen hours per week, and is generally considered distinct from a “solopreneur”. The hourly limits or distinctions between side-gigger and solopreneur are unimportant for the operation of the network 100 of the invention and it's network drivers. As the name implies the side-gigger is one who takes a gig or job on the side, generally in addition to a regular job. There were estimated to be over 12 million side-giggers in the United States in 2015 and it has been estimated that there were over 40 million such workers by the end of 2019. The COVID crisis of 2020-2022 has only increased the importance of this opportunity for people.

The fifth category of Tuler network users is the Network Non-fungible Goods Selectors for the network. Some construction goods, most notably lumber, are not actually fungible goods for each construction job, despite what some vendors and others in the industry suggest. Fungible goods are, of course, items that are interchangeable because they are identical to each other for practical purposes. Lumber, 2×4s for example, may be considered as a fungible good within a vendor's inventory, sales and accounting systems, but in practice are not fungible for all construction projects.

Lumber is a wood product, sawn and shaped from timbers of harvested trees. By its nature, wood is not of uniform consistency and therefore will contain defects that impact the appearance of the lumber that is created from the wood material, and which may impact the structural characteristics as well. In the U.S., lumber is assigned a grade which establishes a measure of consistency in the final products produced by mills. These grades are used to define both the quality of the lumber products delivered and to provide the buyer with a means to estimate the cost and waste associated with the selection of a given grade of the product as raw material. There are acceptable grading systems for both softwood and hardwood lumber. As an illustration a batch of 2×4s may be perfectly acceptable for creation of forms for concrete work (Grade number 4 “economy” “Contains numerous splits, knotholes and similar defects, which large areas of waste wood. Will not paint well.”), but not for shelving (which may require a Grade No. 1 “Construction” that is describes as “Contains moderate number of tight knots. Paints well”).

The Network Non-fungible Goods Selectors for the network 100 are pre-approved goods selectors that may be employed when a non-fungible good is desired from a network vendor. They may or may not be independent from the vendor (and even semi-independent from the vendor), and they have knowledge of and ability to categorize such non-fungible goods according to an accepted grading scheme. When a non-fungible good is selected by a user in an order the Network Non-fungible Goods Selectors associated with or closest to the designated vendor will select this portion of the order and grade and document the selections. Note that if an order requires the lowest grade of an otherwise non-fungible good then the Network Non-fungible Goods Selector is not needed. The implementation of Network Non-fungible Goods Selectors can better match the goods ordered to a selected job such that a work crew does not run out of material on a site and, alternatively, the an order does not include an excessive amount of goods to account for non-acceptable goods.

A sixth category of Tuler network users is the construction equipment rental vendors which are network vendors for the rental of construction equipment. The construction equipment rental vendors are not significantly different from the construction material vendors and may include an overlap of some of the same vendors. Users in the network 100 may have different roles and different user statuses in the network. The construction equipment rental vendors can be large commercial outlets like 84 Lumber, Home Depo or Lowes; or smaller equipment rental vendors.

A seventh category of Tuler network users is the Contractor user. In construction, a contractor is technically anyone who performs work under a contract, and typically refers to the person or company who has a direct contract with the property owner or property manager of the project. A “subcontractor” is historically a company or person providing labor or services that does not have a direct contract with the owner. Subcontractor are often simply called “subs” in construction. For example, on a residential construction project, common subcontractors are carpenters, plumbers, or electricians. Subcontractor are often self-employed or small business owners that specialize in a particular niche in the construction industry. Subcontractor have the difficulty of payment assurance as they are further down the payment chain. The network 100 of the invention facilitates historical “subs” to be contractors and alleviate the payment issues. Additionally the Contractors traditionally have the issue of collecting lien waivers as a necessary step before payment while the network 100 of the present invention minimizes this issue. The network 100 of the present invention minimizes problems in the construction payment system.

An eighth category of Tuler network users is the labor user. The labor user is simply a temporary worker, or side gigger, that can be used for a construction job in the network 100. The laborers are divided into skilled laborers, unskilled laborers and equipment operators. Skilled laborers are generally tradesmen, and unskilled laborers are standard work hands, while equipment operators are those licensed or trained in operating particular construction equipment.

A final category of Tuler network user is the project professional user which includes Architects, Professional Engineers and Network Inspectors. Certain engineering jobs require the input of professional that are not really considered subcontractors, such as architects and professional engineers. Architects and engineers are often involved at the inception of a project to help develop, generally for the project manager or consumer, a project plan (e.g. a building proposal) that satisfies the consumer's goals and visions and can be physically sound and meet local regulatory requirements. As further examples, an architect may be asked for a building proposal on a given plot, while an engineer may be asked to design a retaining wall for the given plot while either may be employed to design a deck proposal.

Architects and engineers are expected to develop proposals that will fit within the zoning and code requirements of a given jurisdiction. Network inspectors have two roles, first to selectively review proposed construction to assure that it meets local regulatory requirements, and they may be desired for projects in which an architect or engineer was not involved in the planning; and secondly to review built or partially built projects to assure that they meet local regulatory requirements. In either role the network inspector's work can facilitate the inspection by a regulatory agency.

### Network Interaction

As detailed above the present network 100 is preferably accessed by users as a mobile app and is fully functional on portable handheld devices of users. The different class of users will have a different interface or dashboard based upon their designated uses of the system 100. Additionally the system 100 requires location tracking to coordinate the job sites, material, drivers, rental equipment vendors, material equipment vendors and labor. The network 100 utilizes user camera on their portable handheld devices of users for documentation of the job progress for completing detailed records of a job and minimizing disputes and yielding system transparency for the Customer Users to review the complete record of the construction job in question at any time in the process.

The network 100 provides the Consumer User with access to select Network Project Managers for a job (or act as their own) as discussed below, and to review the complete record of the construction job in question at any time in the process. Further, all Non-Consumer Users will be subject to reviews and rating systems, and the consumer will have access to provide reviews and ratings for every Non-Consumer Users associated with the particular construction job at a designated job site.

The network 100 provides the Consumer User with the ability to pay for used goods and services in the network, including the Network Project Managers, delivered construction materials, rented construction equipment and labor for a given project. The network 100 of the invention keeps the customer in control of the payment dynamic by both i) giving the customer a simple verifiable transparent record of the construction job (and its progress) for which the customer is paying and ii) giving him a manner of paying. The simple communication aspects of the platform 100 of the invention will simultaneously give the customer a system 100 for setting any desired customer controls and directives for future aspects of a given project (e.g. “no scheduled work in March on Tuesdays and Thursdays before 9:00 am”), which can enhance his level of acceptance. The billing itself can utilize any conventional billing model for mobile payment systems including what has been called i) Premium SMS based transactional payment models; ii) Direct Mobile Billing models; iii) Mobile web payment (WAP) models; and even iv) Contactless NFC (Near Field Communication) payment models.

Customer driven payment of the invention, within the meaning of this application, means that the customer controls the payment. In traditional payment mechanisms the customer naturally controls the payment as he controls how and when to hand over the cash associated with a bill. Similarly, when a check is written to pay a bill the customer also controls the nature of the payment and is thus customer driven. However, in certain prior mobile payment systems the customer has lost this control and the merchant is “reaching into” the customer's account and pulling out the money and the customer has lost control over the process. Customer driven payment of the platform 100 means that the customer maintains control over the payment, and in the payment industry parlance the customer is “pushing” the money to the Tuler network 100, rather than a merchant “reaching in” and “pulling” out customer funds.

The network 100 provides the Network Project Managers with planning and scheduling tools for construction project management. The Network Project Manager component of the platform 100 can interface with conventional 3-D modelling/layout software as well as conventional construction budgeting tools such that these results can be seamlessly incorporated into the present system 100. The Network Project Manager component of the invention can further interface with existing construction management tools preferred to be used by individual Network Project Managers. The Network Project Managers will thereby easily be able to create a simple and comprehensive transparent record of the construction job in question.

As noted above, the network 100 implements a rating system for all Non-Consumer Users, and the Network Project Managers will have access in the system to selectively provide reviews and ratings for every Non-Consumer Users associated with the particular construction job at a designated job site. While these reviews and ratings are optional for consumer users, it can be deemed essential or part of the process for the Network Project Managers, particularly for contractors and laborers hired for a given job.

The construction material vendors will provide the physical location of the individual stores as well the inventory for the individual stores. Additionally significant is that the network 100 of the invention will integrate with the inventory and sale system of the individual construction material vendor. An operational inventory and sale system for each location of a construction material vendor provides an effective means allowing users to place an order for goods or knowing if and when an order can be filled.

Significant to the invention is that the system 100 needs to automatically review the available inventories of all network vendors within a relevant geographic area of the job site for proper functioning of the system 100. Further as detailed below the network 100 of the present invention can balance inventories among a number of locations increasing efficiencies of the vendor. Thus Integration of the network 100 with the inventory and sale system of the individual construction material vendor can improve operation of the vendor's business.

The network 100 implements a rating system for all Non-Consumer Users, and the construction material vendors will have access in the system to selectively provide reviews and ratings for every Non-Consumer Users associated with the particular construction job at a designated job site, however a review of Network Drivers and Network Non-fungible Goods Selectors will likely be the most relevant, if any, of the Non-Consumer Users for which the construction material vendors may have meaningful inputs.

The present network 100 is preferably accessed by the independent side gigger network drivers as a mobile app on portable handheld devices of these users. The network drivers may be preapproved meaning that their driver licenses and auto insurances are verified as they sign up as network drivers as is the make and carrying capacity of their vehicles. In traditional side gigger fashion, the pre-approved network drivers can select when they wish to work by signing onto the system 100 and advising the system 100 of their availability and then jobs can be funneled to those in within the designated area for a given delivery for a given job site. Location tracking, in particular GPS tracking, can easily allow the deliveries to be tracked from pick up to site delivery. The network drivers will also have access to selectively provide reviews and ratings for every Non-Consumer Users associated with the particular construction job at a designated job site, however it is suspected most reviews from drivers will be limited to vendors and Network Non-fungible Goods Selectors. Documenting the delivery at pick up and drop off at the site is expedited through use of a camera on the driver's hand held device.

The present network 100 is preferably accessed by the Network Non-fungible Goods Selectors as a mobile app on portable handheld devices of these users. The Network Non-fungible Goods Selectors will be preapproved with their knowledge of and ability to categorize relevant non-fungible goods, e.g., lumber, according to an accepted grading scheme, and the location of the selector. They may be simply special workers of a vendor that have the verified knowledge, or independent side-giggers (or technically both if a vendor allows such workers to receive a separate network payment for this service). It is an important function of the Network Non-fungible Goods Selectors to select and grade the selected goods in the network, and use of a camera on the selectors hand held device should greatly expedite this process. The Network Non-fungible Goods Selectors will also have access to selectively provide reviews and ratings for every Non-Consumer Users associated with the particular construction job at a designated job site, however it is suspected most reviews from Network Non-fungible Goods Selectors will be limited to vendors and drivers.

The construction equipment rental vendors will provide the physical location of the individual stores as well the inventory of rental equipment for the individual stores. Additionally the construction equipment rental vendors must supply the rental requirements for each piece of rental equipment, which generally extend beyond the rental price and deposit requirements. For example, there may be vendor imposed age restrictions, or regulatory imposed operator licensing and/or insurance restrictions for a piece of equipment.

The present network 100 is preferably accessed by the contractor user as a mobile app on portable handheld devices of these users. The contractor may be under contract with the customer user through the network project manager and use the system 100 to build a transparent record for the customer user. Alternatively, the contractor may be a general contractor for a customer who is not (originally) a member or user of the network 100, but the contractor user still elect to utilize the network 100 for the ease it creates in getting materials and equipment and labor as well as creating a transparent record to ease and facilitate payment. As noted above, the network 100 implements a rating system for all Non-Consumer Users, and the contractor user will have access in the system 100 to selectively provide reviews and ratings for every Non-Consumer Users associated with the particular construction job at a designated job site, and the contractor inputs can include most every category of Non-Consumer User.

The present network 100 is preferably accessed by the labor user for the labor component 40 as a mobile app on portable handheld devices of these users. The network preferably obtains the category of the laborer as skilled, unskilled or operator, a resume/work history of the laborer including certifications/qualifications relevant for his/her designation, payment particulars (social security number and related payment parameters), and insurance particulars. The Tuler network 100 in the labor component 40 can attend to payments to the laborer as well as proper reporting (1099's) for the worker at year end. As noted above, the network 100 implements a rating system for all Non-Consumer Users, and the labor user will have access in the system to selectively provide reviews and ratings for every Non-Consumer Users associated with the particular construction job at a designated job site,

The present network 100 is preferably accessed by professional users (architects, engineers and network inspectors) as a mobile app and is fully functional on portable handheld devices of users. As noted above, the network 100 implements a rating system for all Non-Consumer Users, and the professional user will have access in the system to selectively provide reviews and ratings for every Non-Consumer Users associated with the particular construction job at a designated job site, if any.

### Operation

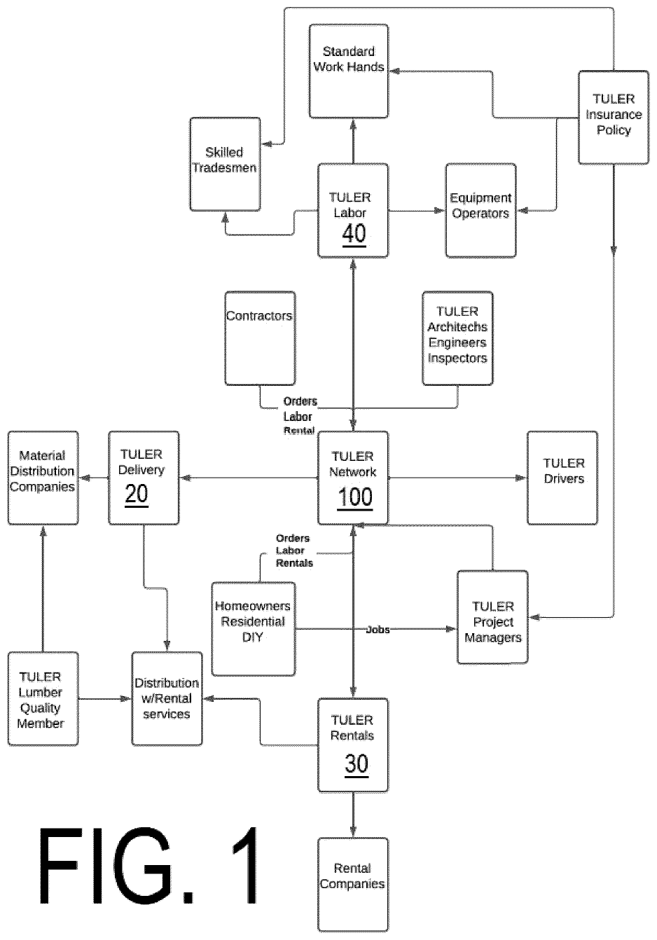

As shown schematically in FIGS. 1-5 the present invention provides a construction networking application system 100, preferably a downloadable app, comprising: a project management component allowing network users to selectively engage network project managers to manage a construction job at an associated jobsite; a construction material order and delivery component 20 wherein network users can order construction materials from network vendors and have the ordered construction materials delivered by network drivers to a designated job site, wherein the system 100 utilizes location tracking, such as GPS, for co-ordination of network vendors and network drivers for an order and an associated job site; a construction equipment rental component 30 wherein network users can rent construction equipment from network vendors for a designated job site, wherein the system 100 utilizes location tracking, such as GPS, for co-ordination of network vendors an associated job site, and wherein the system pre-approves the network user for the rental requirements associated with the desired rental construction equipment and the network vendor; and a construction labor component 40 wherein network users can hire temporary laborers for a designated job site, wherein the system utilizes location tracking, such as GPS, for co-ordination of temporary laborers and an associated job site; and wherein there is cross-platform interaction between the application components.

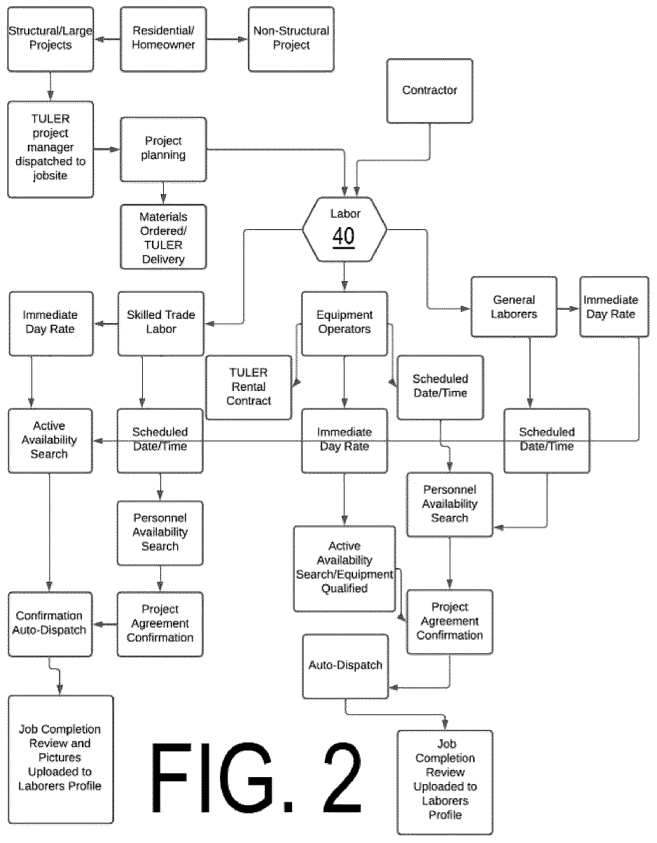

Turning to FIG. 2 consider that a consumer user (e.g., Homeowner, Resident, Business/commercial building Owner, complex manager, etc.) first has a proposed DIY project which can be considered a structural/large project or a non-structural/small project. The main distinction here is that the structural/large project are those that use a Network Project Manager, or general contractor as discussed below, for implementation.

Outside of the system or platform 100 of the present invention the distinction between the structural/large project or a non-structural/small project is that the structural/large project is one in which the consumer user would typically have hired a general contractor. The platform 100 of the present invention can be viewed as a platform 100 that expands the DIY scope for many consumer users by allowing them to undertake projects with a Network Project Manager that they would otherwise send to a general contractor.

The consumer user (e.g., Homeowner, Resident, Business/commercial building Owner, complex manager, etc.) can use the platform 100 for non-structural/small projects by ordering the materials via component 20 and labor via component 40 on the platform 100 and even obtain specialized rental equipment via component 30 as outlined below. The non-structural/small projects do not have significant planning or co-ordination. A representative example is spreading mulch throughout a homeowners planting areas, the homeowner need only order the mulch to be delivered (if they know the amount) together with a laborer to spread the same, and if the homeowner does not know the amount of mulch needed then the platform 100 is even more beneficial. In that circumstance a minimal amount of mulch (to be spread while awaiting delivery of the remaining amount) can be scheduled for delivery via component 20 with the arrival of a laborer via component 40 who is also skilled in estimating the amount of mulch needed. Upon arrival the laborer can first inspect the site and order the remaining needed material through the delivery component 20 of the platform 100 and begin spreading the initial already present amount while awaiting delivery of the remaining mulch such that the platform 100 allows for efficient use of time.

The platform 100 of the invention does not exclude the consumer user from hiring a general contractor for a structural/large project and the contractor would act as the network project manager in the system 100. The transparency of the system 100 and the record of work done and by whom would assist the general contractor/project manager in the planning and execution of the job. As noted above the Network Project Managers may be internalized to the sponsor Tuler and the benefits of a professional construction manager can more easily flow back to the consumer user with the present network 100 as shown.

### Project Management

The project planning is accomplished by the network project manager on the system 100 with the platform maintaining a transparent open record. This may include engaging network architects or engineers (as shown in FIG. 1) as needed and may further include incorporating existing planning tools like floor planning applications, 3D models and other planning software to assist in developing a plan for the project.

The planning step may be described as the objective delineation of scope of the project, which is memorialized in the record of the job on the network 100. Additionally the planning includes budgeting aspects, scheduling aspects, setting performance requirements for the steps of the project, and selecting project participants and equipment. The participants identified at this stage would be the contractors (subcontractors) needed for various job components and the labor to be needed would include general laborers, equipment operators and skilled laborers.

Following the planning stage the project manager will use the network 100 to maximize the resource efficiency through procurement of labor, materials and equipment. The materials will be obtained through a construction material order and delivery component 20, which is discussed in further detail below. Generally the construction material order and delivery component 20 provides that the network users can order construction materials from network vendors and have the ordered construction materials delivered by network drivers to a designated job site, wherein the system 100 utilizes location tracking for co-ordination of network vendors and network drivers for an order and an associated job site.

The network 100 provides proper coordination and control of planning, design, estimating, contracting and construction in the entire process and provides effective communications and mechanisms for minimizing resolving conflicts. Regarding the workers, upon completion of designated jobs the system 100 can obtain the lien releases prior to payments so that the job documentation is complete. If there is an issue or concern the record maintained by the network 100 should minimize conflicts and help resolve disputes.

### Labor Procurement 40

The procurement of labor in component 40 of the network 100 is best shown on FIGS. 1-2. The project planning will identify which general laborers or general work hands are needed at what time and for what jobs in the project. As shown in FIG. 1, the standard work hands or general laborers can be covered by the Tuler Insurance Policy. The general laborers can have suitable payment deducted from their pay, if appropriate or desired. The network 100 preferably can track the location of the day workers to the job site through the Tuler network 100 and when they are at the job site. In this manner the network project manager can assign work to the workers without needing to always manage the workers onsite. The general laborers will be typically instructed to take pictures of the work site before the day's work and at the end of their shift and the network will include these images (with comments as desired) into the record of the job. Thus the network 100 creates a transparent record of what was done and how long these tasks took to accomplish. These jobs can be automatically updated into the resume of the general laborers together with ratings and feedback from the network project managers (or others with input).

The project planning will identify which general laborers or general work hands are needed at what time and for what jobs in the project. As shown in FIG. 1, the standard work hands or general laborers can be covered by the Tuler Insurance Policy. The general laborers can have suitable payment deducted from their pay, if appropriate or desired. The network 100 preferably can track the location of the day workers to the job site through the Tuler network 100 and when they are at the job site. In this manner the network project manager can assign work to the workers without needing to always manage the workers onsite. The general laborers will be typically instructed to take pictures of the work site before the day's work and at the end of their shift and the network will include these images (with comments as desired) into the record of the job. Thus the network 100 creates a transparent record of what was done and how long these tasks took to accomplish. These jobs can be automatically updated into the resume of the general laborers together with ratings and feedback from the network project managers (or others with input).

The project planning will also identify which skilled laborers are needed at what time and for what jobs in the project. Skilled tradesmen can include, for example, Carpenters, Drywall Specialist/Drywall Finishers, Plumbers, Electricians, Masons, Welders, Pipe Fitters, Hvac Specialists, Roofers, Landscapers, Hard-Scapers and Concrete Finisher. Unlike the standard work hands or general laborers which are covered by the Tuler Insurance Policy, many tradesman will have their own insurance. If the tradesman have appropriate insurance the system can record their insurance as appropriate. If the tradesman do not have appropriate insurance then they can be offered suitable insurance via the network and can have suitable payment deducted from their pay, if appropriate.

The network 100 preferably can track the location of the trademan to the job site through the Tuler network 100 and when they are at the job site. As with the general laborers, the tradesman will take pictures of the work site before the day's work and at the end of their shift and the network will include these images (with comments as desired) into the record of the job. Thus the network 100 creates a transparent record of what was done and how long these tasks took to accomplish. The record of the work may further reduce disputes arising later and can provide protection for the tradesmen as well as the project manager and the consumer. The transparent record created is believed to be helpful for minimizing disputes. The open communication between all the stakeholders available on the network should further reduce disputes. Like the general laborers, completed jobs can also be automatically updated into the resume of the tradesmen together with ratings and feedback from the network project managers (or others with input).

The project planning will also identify which equipment operators are needed at what time and for what jobs in the project as well as what equipment. The rental of equipment in the rental component 30 of the system 100 will be discussed below. The operators can be scheduled for operation of designated equipment in accordance with the schedule for the job. As with other laborers the operators can use the network 100 to track time on the job as well as create a record of the job site before and after each workday. Operators will be pre-approved for having the appropriate skill and regulatory licensing to operate the designated equipment. Further the system 100 can confirm the operators have appropriate insurance and offer insurance to be purchased if they do not. Completed jobs are maintained in the record of the job as well as uploaded to the operator's profile.

### Construction Material Order and Delivery 20

As noted above the network 100 includes a construction material order and delivery component 20 wherein network users can order construction materials from network vendors and have the ordered construction materials delivered by network drivers to a designated job site. The independent drivers will generally be able to immediately deliver the ordered goods at a much faster time than either the vender employees operating on a route type delivery system and faster than having the work crew sending a worker to pick up the supplies. The independent driver model for deliveries is not dissimilar from that used by DOORDASH or UBER EATS food delivery systems or UBER or LYFT ride sharing services. Except the system 100 of the present invention will also evaluate the vehicle capacity of the available drivers so that only those that can carry and deliver a particular order are chosen. Additionally the system 100 will evaluate the particular vendor(s) most appropriate to supply a given order, which is not a relevant parameter in other product delivery systems.

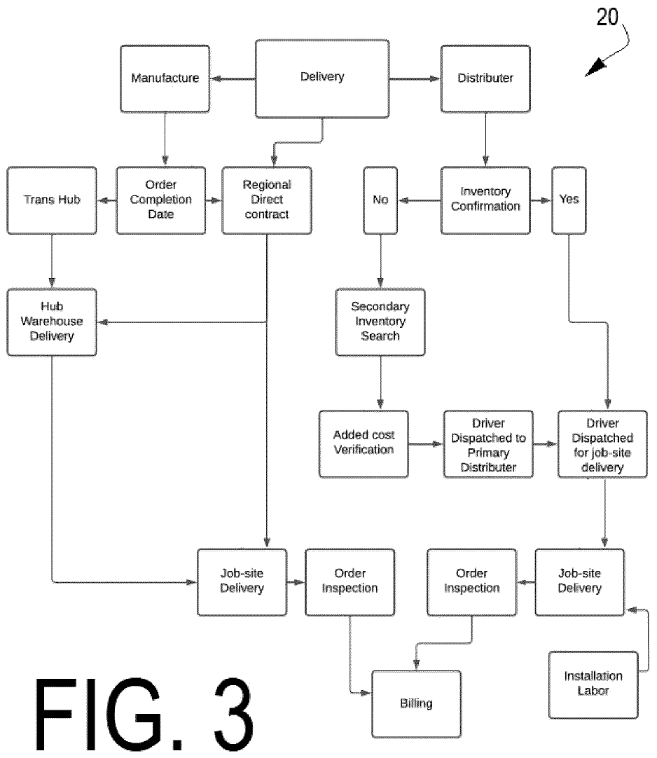

FIG. 3 schematically illustrates the delivery of such ordered constructions goods via the component 30. The first step is determining if the goods desired, based upon inventory listings of vendors, is available from a distributer of manufacturer (each of which can be considered a vendor). If the network indicates that these goods are most appropriately ordered and delivered from a distributer then there is an inventory confirmation step to assure that the goods are found in the inventory of a vender location close to the job site. In the ordinary course the presence of the goods in inventory will be found and the system will coordinate that delivery. The network can use GPS or other location tracking to monitor the entire delivery from the vendor to driver to the jobsite. As with the workers, the drivers will be required to take an image of the goods at pick up and at delivery to add to the transparent record for this job. The record of the goods as pick-up and delivery and the acceptance at delivery should minimize disputes as to product damage and the like.

The system 100 also as an inventory balance protocol for vendors. If the inventory lists indicates that a desired product is carried by the vendor, but the confirmation of the location(s) near the job site indicates that the product is out of stock then a secondary inventory search is conducted to determine if other locations further from the desired location carry the goods. Obviously if no such products are found the user can be notified that nothing is available at this time and the vendor notified of the missed sale. However, if the product is found at a remote location in a secondary inventory search then the system 100 can verify the purchaser wants to incur an added delivery charge associated with moving the goods from the remote location to the designated location.

Assuming the purchaser agrees then a network driver is dispatched to deliver the goods from the remote location to the primary location that is out of stock. This network driver may be different from the one taking the goods from the primary store to the jobsite or they may be the same. They are starting in different locations and treating them as possibly distinct drivers adds flexibility to the system 100. In addition this inventory balancing can be used to move extra inventory of the remote location to the primary location to be maintained by the vendor to attempt to balance the inventory at the two locations. There is no additional costs for the shipped inventory to the vendor as there already is a driver making this transfer. The vender will keep the excess “balanced” inventory at the primary location, although the network 100 may require the vendor to reserve these for network customers for a minimum time. If the primary location runs out of a standard commodity with a surplus at another location then the balancing will assist the vendor in selling off all their inventory. If a customer (who is not yet a network customer) comes into the primary location after the balancing seeking the commodity in question (but within the reserve time) the vendor's inventory control could note, for example, “We have the item in stock but it is reserved to customers of the Tuler network and if you download this free application and use it you can order it from us and buy it now, or you can wait for us to ship it from the other store or wait till the end of the reserve period and we can sell one of these now reserve units to you if it remains.” The inventory balancing aspect will help the vendors and build the network user base.

The delivery decision may elect to obtain ordered items direct from a manufacturer, a direct regional contact or a manufacturer's hub warehouse in place of a distributor. These are illustrated to illustrate distinct vendor sources for the goods, but the delivery operation is essentially the same. Not shown is the balancing or selecting of the source of goods from between multiple system vendors. The selection criteria can be, for example, combinations of cost and timing of delivery as well as ratings of the vendors.

As mentioned above the system 100 of the invention can incorporate Network Non-fungible Goods Selectors employed when a non-fungible good is desired from a network vendor. They may or may not be independent from the vendor, and they have knowledge of and ability to categorize such non-fungible goods according to an accepted grading scheme. When a non-fungible good is selected by a user in an order the Network Non-fungible Goods Selectors associated with or closest to the designated vendor will select this portion of the order and grade and document the selections. This is shown schematically in FIG. 1 with the Tuler system Lumber quality member. As noted above the implementation of Network Non-fungible Goods Selectors can better match the goods ordered to a selected job such that a work crew does not run out of material on a site and, alternatively, the an order does not include an excessive amount of goods to account for non-acceptable goods.

### Construction Equipment Rental 30

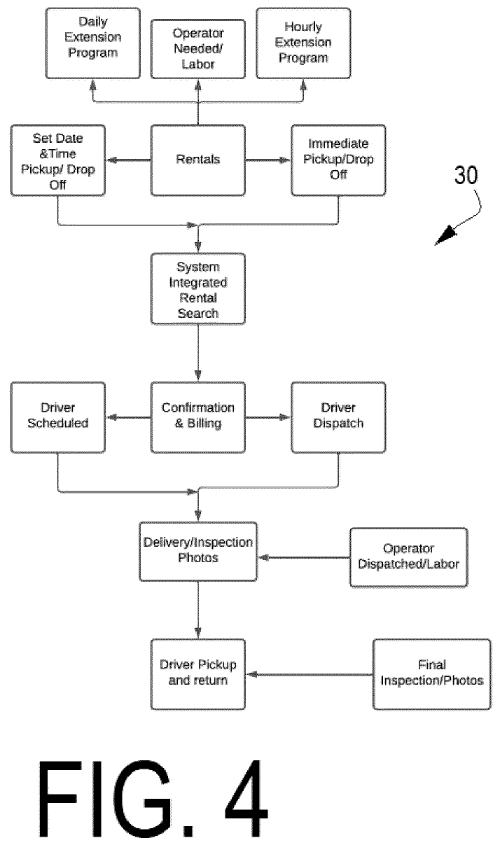

The platform 100 of the invention provides a construction equipment rental component wherein network users can rent construction equipment from network vendors for a designated job site, wherein the system 100 utilizes location tracking for co-ordination of network vendors and an associated job site, and wherein the system 100 pre-approves the network user for the rental requirements associated with the desired rental construction equipment and the network vendor. This is schematically shown in FIG. 4. When a rental is desired the system 100 will determine if a specialized operator is needed and evaluate the location of the job site and the time the equipment is needed to match this with rental venders within the given location area. The network 100 can offer rental extensions to members as well to allow for benefits for tiered membership in the network 100.

As detailed above the confirmation and billing step has the system 100 pre-approve the network user for the rental requirements associated with the desired rental construction equipment and the network vendor. Thus the system 100 will verify the rental customer has the prerequisite to rent all before the equipment leaves or the renting party appears onsite at the rental agency. The system 100 may have the equipment delivered or picked up at the store by the party renting. In either case prior to the equipment changing hands there is a documented inspection that is uploaded into the record for the job. In a similar fashion the equipment is documented upon return. The documentation is intended to reduce issues with rental of construction equipment. Further where the equipment requires a special operator the system can cooperate with the labor component to assure that a proper operator is present. The timing of the job will coordinate the availability of the operator and the equipment to avoid downtime. This illustrates in part that there is cross-platform interaction between the application components.

### Conclusion

The present invention provides the next generation of construction delivery and labor service. This system 100 reduces the time and productivity lost on a job site when unforeseen materials are needed, and the time waiting of deliveries from distributors based upon the position is a designated route delivery queue. The present system 100 streamlines the equipment rental process and integrates the same into the remaining plan and schedule of a job. The system 100 simplifies the hiring on construction labor for skilled and unskilled work as well as for system operators. The system 100 may be described as a fast and efficient construction and labor service. The system 100 utilizes the existing inventory and sale systems of vendors to locate needed material and allows for the creation of reliable labor profiles for workers in the network.

1. (canceled)

2. (canceled)

3. A method of operating an online system for online construction material
order and delivery comprising the steps of:
providing an online construction material order and delivery networking application system;
providing the physical location of the network construction material vendors to the system;
integrating the system with an inventory and sale system of each of the individual construction material vendors, whereby the system can maintain at least a listing of goods available at each individual construction material vendor;
providing the physical location of a plurality of network drivers to the system before an order is placed, wherein the network drivers are independent of the network construction material vendors
providing distinct interfaces for interacting with the system based different classes of users, wherein the class of the user is upon a user's designated and approved uses of the system and wherein the online construction material order and delivery networking application system is fully functional on portable handheld devices of users;
accessing the online construction material order and delivery networking application system by users via a user's interface which comprises as at least one of a mobile app or a mobile website or the system allows the user to place a phone call to an agent of the system to interact with the system on the user's behalf;
providing the physical location of designated job site to the system;
ordering construction materials for the designated job site from network construction material vendors by network users via the user's interface;
selecting one network construction material vendor and one independent network driver for an order wherein the system utilizes location tracking for co-ordination of network construction material vendors and independent network drivers for an order and the physical location of the designated job site, wherein the location tracking implemented in the system is configured to track user locations through their portable hand held devices;
delivering the ordered construction materials delivered by the independent network drivers to the designated job site; and
paying for the order in the system; and
creating a verifiable transparent record of the order.

4. The method of operating an online system for online construction material order and delivery according to claim 3, wherein further including the step of documenting the detailed records of the construction job utilizing a user's camera on portable handheld devices of the user.

5. The method of operating an online system for online construction material order and delivery according to claim 3, wherein further including the step of utilizing verbal commands for accessing the system when the system is active on a user's device.

6. The method of operating an online system for online construction material order and delivery according to claim 3, wherein the system is configured wherein the system allows the user to place a phone call to an agent of the system to interact with the system on the user's behalf by using a one push Call in button when the system is active on a user's device, and wherein the call in button will place a call from the user to an on-call live sponsor representative agent, who will take the order and place it into the system.

7. The method of operating an online system for online construction material order and delivery according to claim 3, further including the step of evaluating a vehicle capacity of the independent network drivers whereby only those that can carry and deliver the order for the designated job site are selected.

8. An online construction material order and delivery networking application system comprising:
A plurality of user interfaces for the system, wherein the system is configured to be accessed by users through one of both a mobile app or a mobile website and which is fully functional on portable handheld devices of users, wherein different classes of users are present on the system and the different classes of users have a different interfaces based upon their designated uses of the system;
A listing of the of the network construction material vendors associated with the system and a listing of the physical location of the network construction material vendors to the system;
A listing and physical location tracker unit of network drivers for providing the physical location of a plurality of network drivers to the system before an order is placed, wherein the network drivers are independent of the network construction material vendors
An inventory and sale system integration unit configured for integrating the system with an inventory and sale system of each of the individual construction material vendors, whereby the system can maintain at least a listing of goods available at each individual construction material vendor;
An order input unit whereby network users can order construction materials from network construction material vendors and have the ordered construction materials delivered by network drivers to a designated job site;
A location tracking based assignment unit wherein the system utilizes location tracking for co-ordination and assignment of network construction material vendors and network drivers for an order and the designated job site, and wherein the location tracking implemented in the system is configured to track user locations through portable hand held devices of users;
An order payment unit wherein the system is configured to provide each user who has ordered construction materials from network construction material vendors with the ability to pay for the order in the system; and
A documentation unit for creating a simple verifiable transparent record of a construction job for which the user who has ordered construction materials from network construction material vendors is paying.

9. The online construction material order and delivery networking application system according to claim 8, wherein the system is configured to have users utilize user camera on portable handheld devices of users for documentation of the progress of the construction job for completing detailed records of the construction job.

10. The online construction material order and delivery networking application system according to claim 8, wherein the system is configured wherein construction material ordering and delivery on the system may be accessed using verbal commands when the system is active on a user's device.

11. The online construction material order and delivery networking application system according to claim 8, wherein the system is configured wherein construction material ordering and delivery on the system may be accessed using a one push Call in button when the system is active on a user's device, and wherein the call in button will place a call from the user to an on-call live sponsor representative, who will take the order and place it into the system.

12. The online construction material order and delivery networking application system according to claim 8, wherein the system is configured to simultaneously give the user who has ordered construction materials from network vendors a system for setting any desired customer controls and directives for future aspects of a given construction job.

13. The online construction material order and delivery networking application system according to claim 8, wherein the prioritizing construction material vendors and network drivers for the order and the designated job site includes evaluating a vehicle capacity of the network drivers whereby only those that can carry and deliver the order for the designated job site are selected.
